(19) United States
(12) Patent Application Publication
(10) Pub. No.: US 2023/0242350 A1
(43) Pub. Date: Aug. 3, 2023

(54) METHOD FOR THE MACHINE-BASED DETERMINATION OF THE FUNCTIONAL STATE OF SUPPORT ROLLERS OF A BELT CONVEYOR SYSTEM, COMPUTER PROGRAM AND MACHINE-READABLE DATA CARRIER

(71) Applicants: THYSSENKRUPP INDUSTRIAL SOLUTIONS AG, Essen (DE); THYSSENKRUPP AG, Essen (DE)

(72) Inventors: Phillip Esser, Köln (DE); Sophie Ruoshan Wei, München (DE); Martin Krex, Bottrop (DE); David Handl, München (DE)

(21) Appl. No.: 17/927,870

(22) PCT Filed: May 21, 2021
(86) PCT No.: PCT/EP2021/063613

§ 371 Date: Nov. 25, 2022

(30) Foreign Application Priority Data
May 25, 2020 (DE) 10 2020 206 497.0

(51) Int. Cl. B65G 43/02; B65G 23/00

(52) U.S. Cl. CPC B65G 43/02; B65G 23/00

(57) ABSTRACT

The present invention relates to a method for the machine-based determination of the functional state of support rollers (13) of a belt conveyor system (1) during operation of the belt conveyor system, wherein at least one unmanned vehicle (2) with at least one imaging sensor system is provided, by means of which at least sections of the belt conveyor system can be sensed in the form of image data, wherein image data of at least one subregion of the belt conveyor system is captured as thermal image data. In the captured image data of the belt conveyor system, at least one identification image region position is determined automatically, in which at least one subregion of a support roller (13) is imaged. For each identification image region position determined from the image data, an analysis image region position is automatically defined in the thermal image data. In each defined analysis image region position, thermal image data is automatically analyzed and the functional state of support rollers (13) is determined. Furthermore, the present invention relates to a method for the identification of functionally impaired support rollers (13), a computer program configured to carry out these methods, a machine-readable data carrier containing such a computer program, and a device with a data processing device (3) for the evaluation of the captured image data.

The invention relates to a method for the machine-based determination of the functional state of support rollers of a belt conveyor system during operation of the belt conveyor system, wherein at least one unmanned vehicle with at least one imaging sensor system is provided, by means of which at least sections of the belt conveyor system can be sensed in the form of image data, wherein image data of at least one subregion of the belt conveyor system is captured as thermal image data. Furthermore, the invention relates to a method for identifying functionally impaired support rollers of a belt conveyor system on the basis of the aforementioned method, a computer program which is configured to carry out each step of the aforementioned method, a machine-readable data carrier on which such a computer program is stored, and a device for the machine-based determination of the functional state of support rollers of a belt conveyor system during operation of the belt conveyor system, the device comprising at least one unmanned vehicle with at least one imaging sensor system that can be moved along at least one subregion of the belt conveyor system, by means of which sensor system at least some sections of the belt conveyor system can be sensed in the form of image data, and which comprises at least one thermal image sensor device for capturing thermal image data.

Belt conveyor systems (belt conveyors, belt conveyor system, conveyor band systems, band conveyor systems, belt band conveying systems) are often used as stationary or semi-stationary continuous conveyors for transporting bulk materials such as waste, ores, fuels, building materials and the like over a specified conveyor section (transport section). In a belt conveyor system, an endless conveyor belt (transport belt, conveyor band) is set into a circulatory movement by at least one drive station (drive drum). In this case, the conveyor belt is routed as the upper run between two deflection stations at which the conveyor belt is deflected by a deflection roller, from a (starting-side) deflection station to another (end-side) deflection station. From the end-side deflection station, the deflected conveyor belt is returned as a lower run to the start-side deflection station, where it is deflected again and guided again as an upper run. As a rule, the upper run forms the load run (working run, driving run) and the lower run forms the empty run. The conveyor belt is supported in the upper and lower runs of the conveyor belt over the entire length of the conveyor track by support rollers (sliding rollers), which act as support and guiding elements.

Due to their higher carrying capacity and better material handling, in addition to flat-format conveyor belts (in a flat belt conveyor system), conveyor belts with a trough-shaped upper run are also commonly used for bulk goods (as a trough belt in a trough belt conveyor system, for example with a V-shaped hollow with two support rollers each or with a U-shaped hollow, for example on three, four or more support rollers) or a rolled upper run (as a tubular belt/pipe belt, each in a tubular belt conveyor system). Depending on the conveying task, a conveyor belt guided in a trough-shaped or rolled upper run is returned in the lower run in a flat form, in troughed form, or in some cases even in rolled form. A U-shaped hollow is often found in the more heavily loaded upper run and the flat or V-shaped hollow in the returning lower run.

The endless conveyor belt must be supported and guided on the conveyor track both in the loaded upper run and in the returning lower run (there in either the unloaded or loaded state), wherein support is particularly important for the loaded section of the conveyor belt. Support rollers in a support frame structure are used for support and guidance as support elements and guide elements of a support roller station (sliding roller station), wherein the support rollers allow a rolling contact between the support frame structure and the conveyed material. Support rollers have a tread region which is bounded on the end face by two cap regions, the support roller bases. As a rule, the tread region is formed by a cylindrical steel tube section, wherein other materials and geometries are also possible. The cap regions usually form cast caps or sheet metal caps that are pressed into or welded into the end face openings of the tread region. A bearing support is provided in each section of the cap to accommodate an axle passing through the support roller or a kingpin protruding into the inner region of the support roller. The bearing supports are anti-friction bearings (which usually form integral parts of the cap region), so that the support rollers are rotatably mounted via an internal bearing. Typical designs of support rollers are subject to industrial standardization and guidelines (such as DIN 15207, DIN 22112 or VDI 2341).

In a support roller station, at least one support roller is rotatably mounted and supported; usually several support rollers are arranged in a support roller station, especially in the case of support roller stations for troughed or rolled conveyor belts. Support roller stations thus represent support points for the conveyor belt and are typically implemented as a rigid support frame structure (support roller frame, sliding roller frame, roller frame, roller stand) in which the axles of the individual support rollers are arranged either rigidly or as a movable structure (support roller girdle, sliding roller girdle). In such a movable structure, the axles of the individual support rollers are arranged such that they can be moved relative to each other, for example by connecting them to each other via chains. Support roller stations can be positioned individually along the conveyor track, can be connected to adjacent support roller stations as part of an overarching support frame structure, or can be designed as an integral part of the support frame of the belt conveyor system. The total number of support rollers of a belt conveyor system is thus determined by the number of support rollers per support roller station and the number of support roller stations on the entire conveyor track; this therefore depends on the distance between the support rollers in the conveyor direction.

The conveyor belt of a belt conveyor system typically has an upper cover plate and a lower cover plate, between which a load-bearing element (carcass) is arranged, which is designed as an insert. This carcass consists of a fiber layer or a plurality of fiber layers embedded in rubber. The fiber layer is used primarily as a longitudinal member (tension member, belt tension member), so that fibers are arranged in the longitudinal direction of the conveyor belt for this purpose. During operation, the tensile forces acting in the conveying direction (in the direction of transport, i.e. the direction of motion of the conveyor belt and thus in its longitudinal direction) are transmitted or dissipated via these fibers. As a rule, the longitudinal members are textile fabrics, steel cables, high-strength polymers, or equivalent composite systems. As a transverse armoring, additional reinforcing members are often provided that are arranged transversely to the longitudinal direction and reinforce the conveyor belt transversely to the conveying direction. As a rule, these additional reinforcing members are steel cables or textile fabrics. The upper cover plate and the lower cover plate of the conveyor belt are rubber layers, wherein the upper cover plate (support layer, support side) is used to pick up the bulk material and the lower cover plate (sliding layer, sliding side) is in contact with the deflection rollers, drive drums, support rollers and other guide and support elements. As a result of the direct contact of the upper cover plate with the—in some cases sharp-edged—conveyed material, the upper cover plate is usually designed to be wear-resistant and has a greater thickness than the lower cover plate. The thickness of the lower cover plate on the support roller side is in the range of 3 mm to 5 mm for many conveyor belts.

Belt conveyors are exposed to different loads and environmental conditions depending on the area of application and type of the material being conveyed. For example, the requirements on belt conveyor systems in open-cast mining differ from the requirements on belt conveyor systems that are used underground; the same applies to the geographical location, for example, in sub-polar regions or in the tropics. The individual operating conditions of a belt conveyor system lead to specific wear on the individual components of such a system, which requires regular monitoring of the functional state of all wearing components of the belt conveyor system at short intervals. The monitoring of support rollers and in particular their bearings (anti-friction bearings) is particularly time-consuming, as each belt conveyor system has a plurality of support rollers which—unlike the conveyor belt itself—are stationary and can therefore only be checked at the respective installation site. Particularly in the case of support rollers, the ambient climate and the type and composition of the conveyed material have a considerable effect on the level of wear and thus determine the requirements on the quality of the support rollers. If the function of support rollers—and in particular their bearings—is impaired, the rolling resistance which the support rollers exert on the conveyor belt increases, counteracting its movement in the transport direction. This not only results in higher energy requirements when transporting the conveyed material, but also in the risk of damage to the conveyor belt and therefore a total failure of the entire belt conveyor system. In order to be able to detect and replace the functionally impaired support rollers in good time before a total failure, critical parameters of the support rollers must be monitored at short intervals.

An increased rolling resistance of the support rollers results in a higher temperature of the bearings, so that the temperature of the support rollers and in particular the bearings can serve as an indicator of any functional impairments. For example, the warmer the bearing becomes in conveyor operation, the worse the functionality and expected service life of the bearing support rollers might be. The wear on the bearing depends, among other things, on the lubrication and quality of the support rollers used (in particular, the quality of the bearings). Other factors that can give rise to greater wear on the bearings and therefore to higher operating temperatures are, for example, higher rotation speed (corresponding to high conveyor belt speeds and/or small support roller diameters), a higher radial load acting on the support rollers, or a greater distance between adjacent support roller stations. In belt conveyor systems, the temperature of the support rollers is therefore typically checked at regular intervals to monitor the wear in order to be able to determine the functional state of the support rollers. If a temperature increase is observed, a functional impairment can be detected at an early stage, so that appropriate measures can be taken at an early stage in order to minimize the downtimes of the belt conveyor system.

Until now, in most belt conveyor systems, the temperature of the support rollers has been measured by personnel who manually inspect all the support rollers of the belt conveyor system throughout the entire length of the transport section for their fitness for purpose, which requires traveling the distances between the support rollers along the belt conveyor system on foot, by bicycle or in a motor vehicle. Such an inspection is carried out by visual inspection, by means of acoustic testing or by a temperature measurement, for example with the aid of fixed temperature probes, a radiation thermometer (infrared measuring device, pyrometer) or a thermal imaging camera.

Industrial belt conveyor systems with conveyor belt speeds of several meters per second and conveying capacities of several kilotons per hour can have conveyor sections with lengths of 10 km or more. Each support roller station can have a plurality of rollers, and the distances between adjacent support roller stations can be as small as 2 m or less, so that several thousand support rollers can be located in a belt conveyor system. In particular in the mining of mineral raw materials, such as in open-cast mining, the total length of all belt conveyor systems at one site can exceed 100 km. With the resulting large number of support rollers, having an appropriate servicing worker visit all transport sections of the belt conveyor systems on foot or by vehicle in a sequence that is periodically repeated entails a large amount of effort, which results in corresponding costs. In order to reduce these costs, one option that is often considered therefore is to increase the inspection interval. However, if the individual support rollers are inspected at excessively long intervals, the risk of failure of the belt conveyor system increases.

In addition, depending on the respective servicing employee, a manual functional check is subject to a certain range of variation with regard to the specific execution of the inspection, which has a negative impact on the reproducibility of the determined functional state of the support rollers—and thus on the reliability of the inspection as a whole. In addition, when testing individual support rollers, errors by the servicing employee cannot be ruled out (for example, the captured data on the functional state, quality and expected service life of the support rollers or on the maintenance of the belt conveyor systems may be obtained incompletely or incorrectly). Overall, the conventional inspection of the functional state of the support rollers of a belt conveyor system is therefore a highly non-transparent process, which, due to the associated uncertainty, can in turn lead to increased working effort (for example, due to duplicate determinations), which entails increased costs.

Consequently, one object of the present invention is to provide a method that eliminates the aforementioned disadvantages and which, in particular, allows the functional state of support rollers of a belt conveyor system to be determined more reliably and reproducibly than has been the case up to now, while at the same time reducing the required effort and costs as well as providing better transparency with regard to the functional state of the support rollers, and additionally enabling the operator and maintenance personnel to document the condition of the support rollers and the maintenance history. In this way, a simple and reliable monitoring of the functional state of support rollers will be implemented, which can also be carried out over a longer period of time at short intervals without incurring high outlay in terms of personnel. The aim of this monitoring is additionally to detect wear on the support rollers and the occurrence of any anomalies that may impair their function at an early stage before critical situations arise, in order to be able to overcome them proactively and to reduce maintenance costs as well as downtimes in comparison to conventional methods. Furthermore, it would be desirable to provide such a method, on the basis of which forecasts can be made for the future temporal evolution of the functional state of individual support rollers and to provide a recommendation for specific maintenance plans in accordance with these forecasts, which will help to improve the efficiency of plant operation and minimize any downtimes. A further object is to provide a computer program by means of which the above-mentioned method is carried out, and a machine-readable data carrier containing such a computer program, as well as a device which offers the above-mentioned advantages.

These objects are achieved by a method for the machine-based determination of the functional state of support rollers of a belt conveyor system during the operation of the belt conveyor system, a method for identifying functionally impaired support rollers of a belt conveyor system, which includes the method for the machine-based determination of the functional state of support rollers, a computer program which is configured to carry out each step of the above-mentioned methods, a machine-readable data medium on which such a computer program is stored, and a device for the machine-based determination of the functional state of support rollers of a belt conveyor system during operation of the belt conveyor, having the features specified in the independent claims. Preferred refinements of the invention are obtained from the dependent claims, the following description and the drawings.

The invention relates to a method for the machine-based determination of the functional state of support rollers of a belt conveyor system during operation of the belt conveyor system, wherein at least one unmanned vehicle with at least one imaging sensor system is provided, by means of which at least sections of the belt conveyor system can be sensed in the form of image data, wherein image data of at least one subregion of the belt conveyor system is captured as thermal image data, wherein in the captured image data of the belt conveyor system at least one identification image region position, in which at least one subregion of a support roller is imaged, is automatically determined, for each determined identification region position from the image data an analysis image region position is automatically defined in the thermal image data, and in each defined analysis image region position, thermal image data is automatically analyzed in order to determine the functional state of support rollers. In particular, subregions of support rollers that contain their bearings (anti-friction bearings) are most important.

A method for the machine-based determination of the functional state of support rollers of a belt conveyor system is a method in which, for individual support rollers or a plurality of support rollers, the respective functional states of the individual support rollers are determined by a machine-based means, i.e. with the substantial involvement of a machine. The functional state here is the state of a support roller in terms of the extent to which it can fulfill its defined function, i.e. supporting the conveyor belt in a rolling motion which presents at most a minimal (ideally negligible) mechanical resistance to a longitudinal movement of the conveyor belt; a support roller that does not perform this task or does not perform it sufficiently well is functionally impaired. In such a method the functional states of all support rollers are preferably determined. As the method is specifically limited to determining the functional state of the support rollers, it will not be possible to detect any functional impairments of other belt conveyor system components, such as damage to the conveyor belt. However, it may be possible to supplement the method according to the invention with further measures and thus create a combined new method in which, in addition to the functional state of the support rollers, a functional impairment of other components can also be determined.

It is important that the method according to the invention is used to determine the functional state during the operation of the belt conveyor, so that the operation of the belt conveyor system does not have to be interrupted for determining the functional state. The functional state determination in the present case is based on the heat generated on the support rollers during operation of the belt conveyor system, so that the present method is particularly suitable for an application during ongoing operation.

For the method according to the invention at least one unmanned vehicle having at least one imaging sensor system is provided, possibly also multiple unmanned vehicles. A vehicle is understood to mean any means of locomotion or means of transport, regardless of whether or not it is suitable for the carrying people. In principle, this term covers in particular land vehicles (earthbound vehicles), for example road vehicles (such as those equipped with tires), off-road vehicles (such as those with tires or track chains), rail vehicles, aircraft (airborne craft) and marine vehicles, and in particular track-bound vehicles (those with or without track guidance, such as rail vehicles or cable cars) and track-less vehicles. In this case, it is particularly advantageous if a hovering platform (multicopter, in particular a quadrocopter (quadricopter, quadrotor)) is used as the vehicle. Designs differing from this are also possible, for example a gondola suspended from a guide cable and the like. An unmanned vehicle (drone) is a vehicle in or on which no person is or need be present during its motion; in the broadest sense, this term also includes mobile robots. The unmanned vehicle can be designed in any way, for example as a remotely operated vehicle (ROV) or as a semi-autonomous unmanned vehicle, but primarily as an autonomous unmanned vehicle. A remotely operated vehicle is a vehicle controlled and monitored by operators, but who are not located in or on the vehicle; such a remote operation is often implemented as a radio remote control. The operators may be human beings or external control systems which are not located on the vehicle; such an external control may be implemented as an external data processing device, for example. A semi-autonomous vehicle is a semi-automated vehicle in which an operator has to perform individual tasks during operation, but these can also be carried out via remote control. In contrast, an autonomous vehicle is a vehicle that travels independently and thus operates independently (i.e. without the direct intervention of a driver or operator) and behaves largely autonomously in doing so. In the case of an autonomous vehicle, the vehicle has a control system located on the vehicle. Typically, an autonomous vehicle follows predefined route, wherein the route guidance can be specified, for example, in the form of waypoints to be headed to. The vehicle heads to these waypoints by means of a satellite-based position detection system, for example, such as a receiver for a satellite navigation system such as GPS, or by means of an optical image acquisition system. As a rule, an autonomous vehicle has additional systems that allow autonomous driving (automated driving, piloted driving), such as a collision avoidance system or an automatic alignment system, to ensure an optimum orientation at specified waypoints to capture image data of the target objects in the best possible way.

As an imaging sensor system a sensor arrangement (detector) is provided, which, in particular in an imaging process, generates a quantitative two-dimensional or three-dimensional image from measurement variables of a real object in its environment and outputs this as image data. These measurement variables and/or information derived from them are spatially resolved by the sensor system and are output in encoded form via further parameters such as intensities and/or colors as (in particular digital) image data, i.e. as datasets in which the respective image information of the imaged objects is represented in a coherent manner. Two-dimensional images are primarily image representations (graphical images) in which the pixels are arranged in two dimensions; such two-dimensional images can be generated and displayed, for example, monoscopically or stereoscopically. In contrast, three-dimensional images are primarily image representations in which the pixels are arranged in three dimensions, for example in the form of point clouds. In addition to the pixel representation, two-dimensional images and three-dimensional images can also be composed of elementary two-dimensional or three-dimensional geometric shapes (primitives, basic objects, basic graphic shapes, basic spatial reference shapes, for example for two-dimensional vector graphics or 3D models) or combinations thereof with pixels. Such a sensor system has at least one sensor device, but may also contain additional sensor devices. The measurement values can be, in particular, the wavelength and intensity of the electromagnetic radiation emanating (emitted, reflected or scattered) from the object from a wavelength range of 100 nm to 1 mm. In this case, the sensor devices can be image sensor devices such as cameras, for example a still-image camera for recording stationary (still) images or a moving-image camera for recording moving images (movies, videos), in particular a thermal imaging sensor device, a photographic image sensor device, or an ultraviolet image sensor device. A thermal imaging sensor device can include a thermal imaging camera (thermography camera, thermal camera, thermal image camera, thermo-camera, infrared camera, thermal imaging device), which is used to acquire primarily infrared radiation (IR radiation, thermal radiation) from a wavelength range of approximately 700 nm to 1 mm and provide it as thermal image data, in particular from the near infrared range (NIR) from 700 nm to 1,000 nm or from the medium infrared range (MIR) from 3.5 μm (microns) to 15 μm (microns). A photographic image sensor device can be a photographic camera (optical camera, RGB camera), which is used to acquire primarily visible light from a wavelength range of approximately 380 nm to 780 nm (in particular up to 700 nm) and provide it as photographic image data. An ultraviolet image sensor device can be, for example, an ultraviolet camera (UV camera), which is used to acquire primarily ultraviolet light (UV radiation) from a wavelength range of approximately 100 nm to 380 nm and provide it as ultraviolet image data. In such a sensor arrangement, the image can also be generated from other measurement variables in the imaging procedure, for example from the transit time or frequency shift of a signal emitted by the sensor arrangement and reflected by the environment, from which in a scanning procedure (e.g. laser scanning, Lidar/Ladar, sonar or radar) spatially-resolved distance information can be obtained and provided as distance image data. In addition, the unmanned vehicle may have other sensor devices in addition to the imaging sensors in order to detect other parameters from or in the environment.

According to the invention, it is also provided that at least sections of the belt conveyor system can be sensed in the form of image data by means of the sensor system. Image data from at least one subregion of the belt conveyor system is captured as thermal image data. Such thermal image data often contains only one intensity value as a measurement variable, which is correlated with the intensity of the infrared radiation emitted from the surface of the imaged object and thus represents the spatial profile of the surface temperature of the object. In addition to the thermal image data, the sensors can also be used to sense other image data, such as photographic image data. For sensing, the unmanned vehicle can be moved along at least one subregion of the belt conveyor system, for example by moving it on the vehicle itself by its own drive unit or by an external drive. The detection of at least sections of the belt conveyor system can also include the possibility of capturing the entire belt conveyor system (e.g. in the form of moving images taken while the unmanned vehicle is moving along the entire belt conveyor system). As a rule, however, due to the size, only a subregion of the belt conveyor system is captured (and therefore sensed) by the sensor system using the sensor devices of the sensor system. It is possible, for example, that no image data is captured for subregions of the belt conveyor system in which there are no support rollers. This is independent of the fact that in practice, multiple unmanned vehicles can be used to sense the support rollers over the entire length of the belt conveyor system, or that the sensing of the entire belt conveyor system is divided into a plurality of individual steps in each of which only a subregion of the belt conveyor system is detected by sensors.

According to the invention, it is also provided that in the captured image data of the belt conveyor system at least one identification image region position is automatically determined, in which at least one subregion of a support roller is imaged. Automatic means that the system performs the specific action—in this case the determination of the identification image region position—as part of an automatic process according to a defined plan or in relation to defined states, without the direct intervention of human operators. This does not exclude the possibility that the automatic performance of the specific action can be interrupted by the intervention of human operators, for example in a hazardous situation, or that some steps outside of the automatically performed action can (or even must) involve intervention by human operators, or that the action was prepared by human operators prior to its actual execution, such as in the programming of the appropriate control or regulation, or training in the context of machine learning.

In the present case at least one identification image region position is determined automatically in the image data. At least one identification image region position means that one identification image region position or else a plurality of identification image region positions is determined in the image data; if no identification image region position is determined in image data, then it is not necessary to feed this data to a further processing stage. An identification image region position is the position of an image data region (i.e. a region within the image data) in which a specified target object or parts of it have been detected, for example as the result of an image comparison or pattern recognition. An image comparison involves comparing captured image data directly with pre-defined reference image data acquired at an earlier time. In pattern recognition, the acquired image data (possibly after pre-processing for data reduction, i.e. in order to reduce the complexity of the image data by removing unwanted or irrelevant image data, for example in the context of filter operations, threshold operations, averaging operations or normalization operations) is subjected to feature extraction and feature reduction, followed by a classification of the features into corresponding classes and an image recognition. In the case of image data of a belt conveyor system, in addition to the support rollers (including the bearings of these rollers), other components of the system may be considered as appropriate classes for the target objects to be identified, such as support frame elements of the support frame structure, foundations, conveyor belts, deflection stations, shelters, baffles, cables, hoses and the like, but also the conveyed material or commonly occurring structures in the environment such as rocks. Image regions in which structures are located that are not assigned to support rollers but rather to other target objects instead, can thus be excluded from further analysis. Typically, a classification based on multiple classes firstly allocates an appropriate probability value to the objects for each class and then assigns the object to the class with the highest probability value.

In this case, it is particularly important to recognize support rollers and their parts, and so the classification of individual elements from the image data to the class “support rollers and parts thereof” could be sufficient. Classification refers to the grouping (division, assignment) of objects according to certain features into predefined classes (groups, sets, categories), which together form a classification, i.e. a collection of abstract classes (concepts, types, categories) that are used for discrimination and ordering. However, it is also possible and practical to assign the plurality of individual elements not simply to a single class, but to a plurality of different classes. Instead, it is also possible to automatically determine the at least one identification image region position in the captured image data of the belt conveyor system by automatically detecting image data regions in the image data in which at least one identifiable object is imaged, automatically detecting support rollers or subregions of support rollers among the identifiable objects in the image data regions thus detected, and for each detected support roller and for each detected subregion of a support roller, providing the position of the image data region in which the support roller or the subregion of the support roller is imaged as an identification image region position. This means that among the identifiable objects only support rollers or subregions of support rollers are identified, and so the identifiable objects are not classified into other, likewise possible assignment classes, for example as support frame elements of the support frame structure, foundations, conveyor belts, deflection stations, shelters, cables, hoses, conveyed material or environmental structures, but the detection would be limited to the detection of support rollers and their subregions. As a result of limiting the identification of identifiable objects to only one assignment class, namely that of the support rollers or their subregions, the identification step is greatly simplified.

If a subregion is determined in the image data in which at least one subregion of a support roller (i.e. one or more objects selected from the list comprising a support roller or a subregion of a support roller, which also includes a plurality of support rollers or a plurality of their subregions as well as combinations thereof) is imaged and detected, then the position of the detected subregion within the image data represents its identification image region position. Typically, an identification image region is chosen such that the support roller or its subregion is centrally located within it. The shape of the identification image region, the position of which within the image data represents the identification image region position, can be chosen arbitrarily. As a rule, a simple geometric shape is selected which encloses the detected support roller structure as a frame, for example a rectangle, a circle or an ellipse for two-dimensional image datasets, a cuboid, a sphere or a cylinder for three-dimensional image datasets (of course, more complex shapes are possible, such as two-dimensional or three-dimensional splines). In the case of two-dimensional image datasets, it is practical to specify the respective identification image region position in the form of two-dimensional coordinates of the identification image region, for example as Cartesian coordinates or polar coordinates within the image data, in the case of three-dimensional image datasets in the form of three-dimensional coordinates of the identification image region, for example as Cartesian coordinates, polar coordinates or cylindrical coordinates within the image data. For a rectangular frame, its position can thus be indicated for example by coordinates of opposite corners (i.e. in the form of two Cartesian coordinate pairs) and for a circular frame, for example, by the center and radius (i.e. a Cartesian coordinate pair and a distance).

According to the invention, it is also provided that for each identification image region position determined from the image data, an analysis image region position is automatically defined in the thermal image data. The analysis image region position is the position in the thermal image data in which an analysis is performed after the definition, to determine the functional state of the support rollers shown in the identification image region. The position information obtained from the image data for the identification image regions is therefore transferred to the analysis image regions of the thermal image data. If the sensor device used to capture the image data that was used to identify the identification image regions is arranged spatially close to the thermal image sensor device and both sensors are aligned identically (or are even identical to each other), the identification image region positions can even be adopted unchanged as corresponding analysis image region positions. If the sensor devices are different and differ in their imaging angle, field of view sizes, positions and orientations, then static geometric differences can be determined in advance and dynamic differences (e.g. due to the arrangement of sensor devices on movable robot arms) can be determined at the respective time, so that the respective spatially corresponding analysis image region positions can be determined geometrically from the identification image region positions.

Finally, according to the invention, thermal image data is automatically analyzed in each defined analysis image region position in order to automatically determine the functional state of support rollers. As part of the analysis of the thermal image data, within each analysis image region position (corresponding to the respective identification image region position), the respective functional state for each support roller that is completely or partially represented in the thermal image data is automatically determined based on the thermal information (temperature information) of points contained in the thermal image data. The fact that not all of the thermal image data in a thermal image is analyzed, but only a small, component-specific region of that data, ensures that relevant data is primarily used to determine the functional state, so that a reliable and at the same time transparent automatic analysis with meaningful results of high significance is actually possible at all. Although the method according to the invention can be used to determine the functional state of individual support rollers, it offers particular advantages when determining the functional state of a plurality of support rollers, in particular when simultaneously determining the functional states of multiple support rollers of a support roller frame or a support roller girdle, and when applying cross-image determination of the functional state of a support roller which is shown in multiple images. This method is also particularly practical for troughed conveyor belts or rolled conveyor belts, as in such systems the support rollers are only partially concealed by other elements of the belt conveyor system, making them particularly easily accessible for automated inspection.

The method according to the invention contains many steps in which an automatic evaluation is performed, for example in the context of recognition or classification. Such an automatic evaluation is carried out, for example, during automatic detection of image data regions (in particular in the automatic identification of image data regions in which identifiable objects are represented and in the automatic assignment of an identifiable object to a class, in particular to support rollers or subregions of support rollers), in the analysis of thermal image data in the analysis image region position (in particular in the automatic selection of thermal image data in the defined analysis image region positions, and in the automatic assignment of determined temperature data to a functional state), in the automatic forecasting of roller service lifetimes and in the automatic creation of maintenance plans or image-based position determination. Within the method according to the invention, the individual steps in which such an automatic evaluation is carried out can in principle be implemented as desired, for example by means of a fixed set of rules consisting of evaluation conditions and corresponding limit values. However, it is particularly advantageous to carry out individual or multiple—possibly even all—automatic evaluations within the context of methods based on machine learning (ML), and hence this design is particularly preferred. Machine learning refers to a method in which learning algorithms develop a complex statistical model from learned sample data (training data). This model can then be applied to data of the same type as the sample data, or of a type similar to the sample data, to obtain an automatic evaluation without explicitly programming an evaluation scheme for the purpose. Such a statistical model can be obtained, for example, on the basis of artificial neural networks (ANN). These are formed from a plurality of nodes arranged as layers (levels) in data structures. During the training phase, weights (weighting factors) at the connections between the nodes are typically varied until results are achieved that correspond to the input data. If a criterion or structural element that can serve as the basis for an evaluation is known in advance, this criterion is included in the learning process and conveyed to the artificial neural network. Such an artificial neural network can be implemented in principle in the unmanned vehicle itself or separately from it, for example on an external data processing device, for example a server or in a computer cloud.

According to one embodiment, the method can be carried out such that image data of at least one subregion of the belt conveyor system is captured as thermal image data by moving the at least one unmanned vehicle with the at least one imaging sensor system, comprising at least one thermal image sensor device for capturing the thermal image data, along at least one subregion of the belt conveyor system, image data from at least one subregion of the belt conveyor system is captured with the imaging sensor system and the image data comprises at least thermal image data, in the captured image data of the belt conveyor system the at least one identification image region position is automatically determined by automatically detecting image data regions in the captured image data, in which regions at least one subregion of a support roller is imaged, and the position of the respectively detected image data region is automatically provided as the identification image region position of the respective support roller, for each identification image region position determined from the image data an analysis image region position is automatically defined in the thermal image data by automatically defining, for each identification image region position of the support roller identified from the image data, an analysis image region position of the support roller in the image data, which position corresponds spatially to the respective identification image region position from the image data, by automatically analyzing the thermal image data in each defined analysis image region position, by automatically determining temperature data of the relevant support roller from the thermal image data in the defined analysis image region position of the support roller, and automatically assigning the temperature data determined from the analysis image region position to a functional state of the respective support rollers.

This means that in the captured image data of the belt conveyor system at least one identification image region position is automatically determined by automatically detecting image data regions in the captured image data in which at least one subregion of a support roller is represented. The position of the detected image data region is then provided automatically as the identification image region position of the detected support roller. Such automatic image data region identification can be carried out, for example, on the basis of the general pattern recognition principle described above. This reduces the sensitivity to changes in image acquisition conditions (due to e.g. changing lighting conditions, changing recording positions or temporary masking) that occurs in other recognition methods, such as comparing images with historical reference image data, and thus further increases the reliability and transparency of the functional state determination.

For each identification image region position of a support roller determined from the image data, an analysis image region position of the support roller is automatically defined in the thermal image data, which corresponds spatially to the respective identification image region position from the image data. If the sensor device used to capture the image data on which the determination of the identification image regions is based is located close to the thermal imaging sensor device and both sensor devices are aligned in a similar way (or even identically to each other), the identification image region position corresponds spatially to the respective analysis image region position in such a way that both positions within the respective image data are spatially identical; if the representation is the same (e.g. with regard to the opening angle, pixel resolution and display region size of the image data), this means that the identification image region position can be adopted directly as the respective analysis image region position; if there are differences in the representation, corresponding conversions are also required for coordinate transformation. If the two sensor devices are spaced apart from each other and/or if the viewing angles differ, further geometric conversions are required to adjust static and/or dynamic differences, such as parallax compensation, in order to determine and define the appropriate spatially corresponding analysis image region position in the thermal image data from an identification image region position in the image data. Here also, an additional efficiency gain and thus improved resource utilization can be obtained by refraining from identifying other targets than support rollers.

When analyzing the thermal image data, temperature data of the respective support roller is finally determined automatically from the thermal image data in the defined analysis image region position of the support roller, and the temperature data determined from the analysis image region position is automatically assigned to a functional state of the respective support rollers. The temperature data (thermal data) of the support rollers can be, for example, the spatially resolved local surface temperatures of the support rollers and in particular of their bearings, but also statistically derived characteristic temperature characteristics of the respective support roller that represent the current thermal state, such as minimum values, maximum values, mean values, center values (medians), local clustering values as well as temperature distribution parameters, especially their width, scatter dimensions and symmetry. Based on the surface temperatures and/or the characteristic temperature characteristics of a support roller or a subregion of a support roller, the functional state (functional status) of the respective support roller is determined and assigned to this support roller.

In accordance with a further embodiment of the invention, the method can be carried out such that the image data that can be captured by the imaging sensor system also comprises photographic image data in addition to the thermal image data, wherein image data of at least one subregion of the belt conveyor system is also captured as photographic image data, the captured image data of the belt conveyor system in which at least one identification image region position is determined automatically is photographic image data, in which photographic image data regions are automatically detected as image data regions, and the position of each detected photographic image data region is automatically provided as the identification image region position. As a result, the sensor system of the unmanned vehicle also has a photographic image sensor device in addition to the thermal imaging sensor device. Image data is captured from both image sensor devices, wherein both thermal image data and corresponding photographic image data are captured from at least one subregion of the belt conveyor system. The photographic image data is used to automatically determine the positions of identification image regions (identification image region positions) in which support rollers or subregions of support rollers are imaged. Based on the identification image region positions determined from the photographic image data, the corresponding analysis image region positions in the thermal image data are defined, in which the thermal image data is then analyzed. Photographic image sensors typically have higher image resolutions than thermal imaging sensor devices, and moreover, thermal imaging sensor devices typically only capture one measurement variable (the surface temperature of the object, often encoded as monochrome intensity or as a color), while photographic image sensors typically capture at least two measurement variables (light intensity and light color/light wavelength). For the detection of target objects such as support rollers, for example by image comparison or pattern recognition, photographic image data therefore generally offers more information than thermal image data. In addition, thermal image data usually only images the shape of the target object, while photographic image data represents other structural elements such as surface textures and shadows, which are not identifiable on a thermal image. When using photographic images therefore, the higher recognition quality, which is based on the distinctive and characteristic display elements of the photographic images, can be transferred to the less distinctive thermal images. Detection based on photographic image data is therefore much more reliable than detection based on thermal image data.

Alternatively, the method can also be carried out in such a way that the captured image data of the belt conveyor system, in which at least one identification image region position is determined automatically, is thermal image data in which thermal image data regions are automatically detected as image data regions, and the position of each detected thermal image data region is automatically provided as the identification image region position. In this case, it is therefore not necessary to use a photographic camera, which makes the design of the vehicle simpler and more compact. In addition, determining the identification image region positions based on the thermal image data offers the advantage of being able to determine the functional state of support rollers even in poor lighting conditions or even in darkness, for example at night, for underground belt conveyor systems or for support rollers in shaded regions of belt conveyor systems. The spatial resolution of current thermal imaging cameras is currently even lower than the spatial resolution of current photographic cameras (which is why the recognition performance when using thermal image data is currently slightly worse than when using photographic image data). The structural simplification as well as the possibility of use in poor or highly variable lighting conditions can compensate for this disadvantage, however, depending on how it is applied. The latter design of the method can of course also be combined with a method in which the captured image data is photographic image data; due to the parallel use of both types of image data for recognition—thermal image data and additionally image data—the recognition accuracy can be further increased, which can also be particularly advantageous in poor lighting conditions.

As already mentioned, individual, multiple or all automatic evaluations (identification steps) can be carried out by applying methods based on machine learning. In accordance with a further embodiment of the invention, it has also proved advantageous to carry out the method in such a way that the recognition quality in the automatic determination of the identification image region position in the captured image data, in particular the recognition quality of the automatic detection of image data regions in which at least one identifiable object is imaged, in particular at least one subregion of a support roller, and/or the recognition quality of the automatic detection of support rollers or subregions of support rollers in the detected image data regions, is improved by means of a learning procedure carried out by means of an artificial neural network, in particular by means of a single-level or multi-level convolutional neural network. Thus, in the automatic determination of the identification image region position in the captured image data, the recognition quality can be improved by using a learning procedure which is carried out by means of an artificial neural network. The determination of the identification image region position in the captured image data involves at least one identification step, which is performed by means of an artificial neural network. This can be in particular an automatic identification of image data regions in which at least one identifiable object is imaged (in particular a support roller or at least a subregion of a support roller), or an automatic identification of support rollers or subregions of support rollers in the detected image data regions. The recognition quality is a statistical measure of the accuracy of the recognition process and represents the total number of correct recognitions as a proportion of the total number of recognitions performed: the better the recognition, the higher (and therefore better) the recognition quality. It is particularly advantageous if the learning procedure is carried out using a single-level or multi-level Convolutional Neural Network. A Convolutional Neural Network (CNN) is an artificial neural network capable of processing input data presented as a matrix. For example, it has a filter layer (convolutional layer) with one or more filters (typically 16 or 32 filters) to analyze the data entered as a matrix in a discrete convolution, the output of which also has a matrix form. The output data of this filter layer can be used as input data for a possible subsequent filter layer, followed by an aggregation layer (or pooling layer), to pass the most representative signal forward to the following layers. This structure can be repeated several times if necessary, the network being terminated by at least one layer with the structure of a regular neural network (fully-connected layer), which is connected to an output layer. The convolutional neural network can be either single-level or multi-level, i.e. only have one level of trainable weights or a plurality of levels of trainable weights.

The method in accordance with a further embodiment of the invention can be carried out in such a way that in each defined analysis image region position, thermal image data is automatically analyzed by automatically selecting thermal image data in the defined analysis image region positions, which is thermal image data of the support rollers, and automatically analyzing the selected thermal image data in the defined analysis image region positions. Thermal image data is automatically selected within the defined analysis image region positions which is thermal image data of the support rollers. The selected thermal image data is then automatically analyzed in the defined analysis image region positions. This limits the analysis of the thermal image data within the analysis image region positions to thermal image data that primarily originates from a support roller and does not include thermal image data that is in the analysis image region positions but does not originate from the surface of the support roller, and therefore is not thermal image data of the support roller and hence does not provide any information on its functional state. The automatic selection of the thermal image data from the analysis image region positions which can be attributed to support rollers or subregions of them can be carried out in methods based on a fixed control scheme or on machine learning. This further reduces the amount of data to be considered in the analysis, thereby reducing not only the effort involved in determining the functional state, but also improving the quality of the determination of the functional state as well as the overall transparency of the determination.

According to a further embodiment of the invention, it is possible to automatically select thermal image data that lies in those subregions within the defined analysis image region positions in which thermal image data is arranged in circular or near-circular contours and/or in which thermal image data corresponds to the temperatures of an equal temperature level. The thermal data in the automatically selected subregions represents the thermal data of support rollers and in particular of their bearings, and is then automatically analyzed. This means that thermal image data that can be automatically selected as subregions is that which lies within the defined analysis image region positions (and thus within the respective defined analysis image regions) and in which the thermal image data is arranged in circular or near-circular contours. The thermal data are arranged in circular or near-circular contours in particular if the measurement variables (for example, the intensity values representing surface temperatures) in the thermal image data have a spatial distribution that has a shape derived from a circle or from a perspective-distorted circle (for example, an oval, in particular an ellipse), which includes subregions of these (for example, an arc, a pitch circle, a circle segment, a ring, a partial ring, an annular section, a partial oval, a partial ellipse and the like); this also includes circular contours, of course. Such circular or near-circular contours can be primarily concentric or confocal in shape. The image region (analysis image region) within each analysis image region position is examined for circular contours and a selection is made, for example, for those subregions that represent the average of all circular or near-circular contours or the centers or focal points of which are identical or are located close together (i.e. at a sufficiently small distance from each other).

Similarly, thermal image data can be automatically selected that is located within the defined analysis image region positions and in which thermal image data corresponds to the temperatures of an equal temperature level. The measurement variable underlying the thermal image data sensing is the temperature (surface temperature) of the object being imaged. If the thermal image data in subregions of the analysis image region corresponds to temperatures above or below certain temperature limits or temperatures from a temperature interval defined by a temperature limit pair, then these thermal image datasets correspond to temperatures of the same temperature level. The thermal image data from the equal temperature level can also be arranged in spatially contiguous regions. The respective temperature limits are defined in advance. For example, at a typical maximum operating temperature for the surface of the support rollers (in particular their bearings) of a belt conveyor system of 70° C., for temperatures from a range of over 70° C. to a maximum of 80° C. monitoring of the support roller at short time intervals may be provided. For temperatures above 80° C. to a maximum of 90° C., replacement of the support roller must be planned, and for temperatures exceeding 90° C. the roller must be replaced immediately. If only support rollers in a potentially critical functional state are to be monitored, then in this configuration temperature intervals can be defined, for example, such that only temperatures of more than 70° C. are selected. If, on the other hand, documentation of the temperature data is also required for rollers with a properly working functional state, the temperature data for all ranges can be determined and only be subjected to further analysis in relevant or potentially interesting temperature ranges. For example, it is possible to apply only the thermal image data from the highest measured temperature interval to further analysis—i.e., for example, thermal image data from temperatures above 90° C.; if these high thermal image data values do not exist, then thermal image data from a temperature interval of more than 80° C. to a maximum of 90° C. can be analyzed, if these do not exist either, thermal image data from a temperature interval of more than 70° C. to a maximum of 80° C., and only if these do not exist, all thermal image data.

According to the two variants described, a selection can be made on the basis of a scheme of fixed rules, but preferably in a procedure based on machine learning. The variants can be used as alternatives, but can also be combined to increase the recognition quality. In this case, for example in the defined analysis image region positions, the subregions in which thermal image data corresponds to the temperatures of an equal temperature level are compared in terms of shape and extent with the subregions in which thermal image data is arranged in circular or near-circular contours. The thermal image data that is ultimately automatically selected is then the thermal image data of a region which results as the common intersection set (intersection surface) of the two subregions from the different variants.

According to a further embodiment of the invention, the recognition quality in the automatic selection of the thermal image data, which is thermal image data of the support rollers, is improved by means of a learning procedure carried out by means of an artificial neural network, in particular the recognition quality in the automatic selection of the thermal image data, which lies in such subregions within the defined analysis image region positions in which thermal image data is arranged in circular or near-circular contours and/or in which thermal image data corresponds to the temperatures of an equal temperature level. As a result, the automatic evaluations on which the automatic selection of the thermal image data, which is thermal image data of the support rollers, is based are thus performed as part of methods based on machine learning, thus improving the recognition quality of this evaluation in learning procedures carried out by means of an artificial neural network. In particular, these may be evaluations related to the automatic selection of thermal image data arranged in circular or near-circular contours and/or corresponding to the temperatures of an equal temperature level.

In accordance with further embodiment of the invention, the method can be carried out in such a way that the image data of the belt conveyor system is assigned to a position in the belt conveyor system and/or for defined analysis image region positions the thermal image data or evaluation information is assigned to an individual support roller of the belt conveyor system, the assignment being performed in particular via a radio-based position determination, by comparing captured image data against reference image data, by detecting the route traveled by the unmanned vehicle, and/or by detecting the orientation of the imaging sensor system. Such an assignment enables a unique identification of the object represented in the image data. As a result, the image data of the belt conveyor system, i.e. the thermal image data and, if applicable, other image data such as photographic image data, can each be assigned to a position as a location position in the belt conveyor system. A location position (location) is a point in space that is uniquely defined by coordinates, i.e. by geographical coordinates, by a relative position specification within the belt conveyor system, or by the distance traveled by the vehicle. The location assigned to the image data can be the location of the objects represented in the image data, the location of the unmanned vehicle, the location of the image sensor device by means of which the image data was captured, or the location of another defined reference point. Instead or additionally, for defined analysis image region positions, the thermal image data or evaluation information can be assigned to an individual support roller of the belt conveyor system. Such an assignment is comparable to the relative position specification described above.

The corresponding location position must therefore be determined in order to assign the position. From an exact location position, the respective support roller can generally be uniquely identified, if necessary by taking into account a viewing direction. The location position can be determined, in particular in a radio-based position determination, from a comparison of captured image data with reference image data, by means of a route detection of the unmanned vehicle and/or by means of an orientation detection of the imaging sensor system. Radio-based position determination can be carried out, for example, via a satellite navigation system such as GPS or Galileo, via a terrestrial radio navigation system such as Decca or Loran, via a short-range navigation system or via a near-range transponder system such as RFID transponders on the support roller stations. For example, the route of the unmanned vehicle can be detected by accurate tracking of the distance traveled by the vehicle and any changes in direction if at least one point of the route is known as a partial reference, such as the starting point, the end point, or a waypoint in between. For example, an orientation of the imaging sensor system can be detected by means of an electronic compass (magnetometer) or an inertial measurement unit (IMU) with inertial sensors on or in the vehicle (including its sensor system), which can be used to record, for example, accelerations and rotation rates in conjunction with time recording; instead, a time-based continuous image data acquisition is also possible (for example as a burst image, film or continuous shot), in which an orientation can be determined based on the time stamp and the direction changes imaged.

A comparison of captured image data with reference image data can be carried out, for example, on the basis of the thermal image data or photographic image data captured by the sensor system (either alone or in combination); these can be captured monoscopically or stereoscopically as single images, image sequences, or moving images. Instead, such image data can also be captured by separate devices, for example as distance data from scanning methods such as laser scanning (including laser scanners with thermal imaging cameras), Lidar/Ladar, sonar or radar. For comparison, this image data is compared with reference data, for example with previously captured reference image data or a previously created spatial (three-dimensional) digital model of the belt conveyor system and its environment, which can be provided, for example, as a three-dimensional point cloud. The comparison can be implemented using a fixed rule set or else as part of a machine learning procedure.

Sometimes the location accuracy of individual methods may not be sufficient to permit a unique identification of an imaged support roller. This may be the case with conventional GPS systems (for example, differential GPS systems offer a higher spatial resolution). In this case, it is practical to use multiple methods to determine the position side by side, such as using a compass system in addition to a GPS system, for example, based on calibrated inertial sensors to ensure the required accuracy.

In accordance with further embodiment of the invention, the method can additionally be carried out in such a way that the temperature data determined from the analysis image region position is automatically assigned to a functional state of a support roller, by either automatically classifying the determined temperature data of the respective support roller to one functional state of a plurality of previously defined functional states or by automatically assigning said data to a functional state as part of a cluster analysis, in particular as part of a multivariate cluster analysis. As a result, the temperature data determined for a support roller can be automatically classified into a single functional state, this one functional state originating from a plurality of previously defined functional states. The classes for the classification must be defined in advance in accordance with the requirements of the specific belt conveyor system; in the simplest case there will be two classes, namely one for support rollers in which a functional failure has already occurred (i.e. for a defective support roller with complete functional impairment) and one for support rollers which have not yet failed to function. Another binary (dual) classification could include a class for support rollers in which no functional impairment has yet occurred, and a class for support rollers in which a functional impairment has already occurred (without distinguishing whether the functional impairment is only minor or whether a functional failure has already occurred). A more meaningful differentiation allows a ternary classification (corresponding to a classification “good”, “medium”, “poor” or “unworn”, “partially worn” and “worn”), in which a distinction is made between support rollers for which no functional impairment has yet occurred, support rollers for which a functional impairment has already occurred but no functional failure has yet occurred, and support rollers that have already experienced a functional failure. In addition, the classification may also include additional classes, wherein further differentiation of the middle of the three classes in particular seems to be useful in order to represent different wear states and to identify different points for a replacement, for example a classification with a total of four classes, five classes, six classes or more. Instead of a classification, it is also possible to perform a cluster analysis for the assignment, i.e. as a method for combining (bundling, clustering) data into different homogeneous groups (clusters) on the basis of similarity structures discovered in the data sets in the course of the method. A cluster analysis is a structure-discovering procedure, so it is not necessary to define individual classes in advance. Optionally, the cluster analysis can be designed as a multivariate cluster analysis and thus depend on more than one variable. It is also useful to rely on methods based on machine learning for evaluations carried out as part of such an assignment, in particular as part of a cluster analysis.

In accordance with a further embodiment of the invention, it may be advantageous if the method is carried out in such a way that the thermal image data in each defined analysis image region position is automatically analyzed by automatically determining temperature data from the thermal image data as characteristic temperature parameters of the respective support roller, wherein the characteristic temperature parameters of the thermal image data in the defined analysis image region positions are in particular minimum values, maximum values, mean values, median values, local cluster values as well as parameters of the temperature distributions, in particular their widths, dispersion dimensions and symmetries. The characteristic temperature parameters are characteristic values that are derived from the temperature and characterize the current state of a support roller; typically, these are characteristic values that are obtained in the context of a statistical analysis of the local temperatures. If the thermal image data does not include the surface temperature directly, it can be calculated from the respective thermal image data before performing the statistical analysis of the temperatures.

In particular, according to a further embodiment of the invention, it is advantageous if the method is carried out in such a way that the recognition quality during the automatic determination of the functional state of support rollers, in particular the classification of the thermal image data, is improved using a learning procedure carried out by means of an artificial neural network. Even if the automatic determination of the functional state can in principle be carried out using any suitable methods, i.e. also on the basis of a scheme of fixed rules, preferred methods used for the automatic determination of the functional state are those based on machine learning. As a result, the automatic evaluations on which the automatic determination of the functional state of support rollers is based are thus performed as part of methods based on machine learning, thus improving the recognition quality of this evaluation in learning procedures carried out by means of an artificial neural network. In particular, these may be evaluations related to the classification of the thermal image data.

In accordance with a further embodiment of the invention, the method can also be carried out in such a way that the functional state, the image data and/or, if applicable, the determined temperature data for the respective support roller are captured in a functional state data collection. A functional state data collection is obtained that contains the current functional state of a support roller, preferably the functional states of all support rollers of a belt conveyor system. For example, such a functional state data collection can be in the form of a database. Such functional state data collections with functional states, image data and/or temperature data (including characteristic temperature parameters) can be used for documentation purposes, for example.

In addition to the current data, such a functional state data collection can also contain historical data that represents past functional states. In this form, it can also be used as a basis for preparing forecasts for the temporal development of the functional state of support rollers. The corresponding data can be stored in a storage device, which is located on the unmanned vehicle, or in an external storage device located outside the unmanned vehicle, perhaps in a data processing device such as a server. In the case of external storage, the data can be transferred to the external data device shortly after the image data has been captured (e.g. in real time or with a time delay), later on in the course of the inspection run by the unmanned vehicle, or only after the inspection run has been completed, for example from a base station (service station) in which the vehicle is located between two inspection runs. For documentation purposes, the photographic data are stored in the form of photographs (photographic images, photographs, RGB images, in particular digital photographs) and the thermal image data are stored in the form of thermal image recordings (thermal images, thermographs, thermal images, thermo-images, in particular digital thermal photographs), wherein position information and distance/route information can be stored separately or may be contained in the corresponding image data as meta-information.

The data contained in such a functional state data collection can be retrieved by the operator or by maintenance personnel, for example in text form or as a graphical display. In this way, it is easy to obtain an overview of different types of status information, for example a detailed list of all support rollers including individual comments and the maintenance history, detailed information on the temperature of individual support rollers, geo-information for the rapid localization of damaged support rollers, overviews for all support rollers on wear and functional failures to date, as well as on predicted wear and failure behavior. This information on the state of the support roller and maintenance history can be added manually if necessary.

Furthermore, according to a further embodiment of the invention, it may be practical if the method is carried out in such a way that, in the event that an identification position for an individual support roller is not detected during the automatic determination of the identification image region position, or temperature data is determined during the analysis of the thermal image data which does not enable the functional state to be determined, a request command is sent to the unmanned vehicle in order to re-acquire image data in the region of the belt conveyor system where the individual support roller is located. In this way, if an error is detected or the data acquisition is faulty, it is possible to initiate the re-acquisition of image data in order to obtain a complete set of analyzable data for the support rollers. The detection of image data can be limited to those support rollers for which no corresponding data is available. The same procedure can be used in the event of an emergency or a fault to examine the individual causes of the irregularities that have occurred during the operation.

The invention also includes a method for identifying functionally impaired support rollers of a belt conveyor system during operation of the belt conveyor system, the method comprising the above-described method for the machine-based determination of the functional state of the support rollers of a belt conveyor system, wherein functionally impaired support rollers are detected, a time for the replacement of the respective support roller is determined based on a comparison with historical data from a functional state database and the determined time for this support roller is output to a communication interface. In such a method, support rollers of a belt conveyor system are identified that are functionally impaired, i.e. that have already failed or are expected to fail in the foreseeable future. The essential step in this method is the method described above for the machine-based determination of the functional state of support rollers, in which functionally impaired support rollers are detected. The currently recorded data is compared with historical data from a functional state database and an optimal time is determined for the replacement of the respective support rollers. In order to determine an optimum time, a forecast of the expected total failure of a support roller is taken into account, as well as system-specific circumstances, e.g. maintenance periods and the like. A prognosis can be obtained, for example, by taking the historical data into account, by extrapolating the historical course of the temperature of a support roller to a defined critical maximum temperature (e.g. as part of a regression analysis) at which a total failure can be expected, for example to a temperature of 90° C. The replacement of this support roller can then be carried out automatically as part of the regular scheduled maintenance operation, which takes place shortly before the critical maximum temperature is expected to be reached. It is also practical to rely on methods based on machine learning for evaluations to be performed as part of such a prediction. Based on such analyses, for example, an efficiency-optimized maintenance schedule can be created for the entire belt conveyor system, in which the downtimes and maintenance costs are minimized and the replacement intervals are maximized. The time determined in this way is output to a communication interface, for example displayed as visual information on a display device, sent as an e-mail to a previously defined e-mail account, fed to a system for plant control and plant monitoring as operating instructions, or inserted as an automatically created calendar entry in appointment management programs. In addition, further measures can also be initiated, for example, required service technicians can be automatically requested or spare parts that are not in stock can be ordered automatically.

This means that in addition to detecting anomalies and current wear of support rollers as part of inspection and monitoring, future behavior can also be predicted, for example for predictive maintenance or when creating a digital system model.

In the event of an imminent functional failure of a support roller and the associated urgent replacement of such a support roller, the output of the maintenance time to the communication interface can also include an alarm signal, if necessary connected with an emergency shutdown of the entire belt conveyor system in order to prevent further damage. Thus, the invention also includes a method for identifying damaged support rollers of a belt conveyor system during operation of the belt conveyor system, the method comprising the above-mentioned method for the machine-based determination of the functional state of support rollers of a belt conveyor system in any possible configuration, wherein damaged support rollers are detected and if a damaged support roller is detected a notification signal is output to a communication interface for this support roller.

The invention also includes a method for creating a digital model of a belt conveyor system, the method comprising the above-mentioned method for the machine-based determination of the functional state of the support rollers of a belt conveyor system in any possible configuration, wherein the functional state and the temperature data determined in conjunction with other process parameters of the belt conveyor system are used as basic data for determining the support roller behavior in the digital model for the respective support roller. In this method also, the method according to the invention represents the essential step, wherein temperature data of each support roller and the functional state determined for it are used in conjunction with other process parameters of the belt conveyor system as basic data, in order to model the individual behavior of the respective support roller in a digital model of the belt conveyor system as a function of changes in the process sequence or in the process conditions and to be able to predict or simulate certain key indicators or operating points of the belt conveyor system on the basis of these basic data.

The invention also includes a computer program which is configured to perform each step of the method described above, as well as a machine-readable data carrier on which such a computer program is stored. Such a machine-readable carrier (computer-readable data carrier, machine-readable storage medium/medium, computer-readable storage medium/medium) contains commands which, when the program stored on the medium is executed on a computer, cause the latter to carry out this method or steps of this method.

Finally, the invention includes a device for the machine-based determination of the functional state of support rollers of a belt conveyor system during operation of the belt conveyor system, the device comprising at least one unmanned vehicle with at least one imaging sensor system that can be moved along at least one subregion of the belt conveyor system, by means of which sensor system at least some sections of the belt conveyor system can be sensed in the form of image data, and which comprises at least one thermal image sensor device for capturing thermal image data, a data processing device for evaluating the captured image data in order to determine the functional state of support rollers of a belt conveyor system during operation of the belt conveyor system, the data processing device having an image region identification module which is configured to automatically identify in captured image data at least one identification image region position in which at least one subregion of a support roller is imaged, an image region definition module which is configured to automatically define an analysis image region position in the thermal image data for an identification image region position identified from the image data, and a state identification module which is configured to automatically analyze thermal image data at a defined analysis image region position to automatically determine the functional state of support rollers.

According to a further embodiment of the invention, the device can be designed in such a way that the image region identification module has an image region detection module and an interface module, the image region detection module of which is configured to automatically detect image data regions in the captured image data in which at least one subregion of a support roller is imaged, and the interface module of which is configured to automatically provide the position of the detected image data region as the identification image region position of the respective support roller, and wherein the image region definition module is configured to automatically define, for each identification image region position of a support roller determined from the image data, an analysis image region position of the support roller in the thermal image data that corresponds spatially to the respective identification image region position from the image data, and wherein the state determination module has an analysis module and an assignment module, the analysis module of which is configured to automatically determine temperature data of the respective support roller in the defined analysis image region position of the support roller from the thermal image data, and the assignment module of which is configured to automatically assign the temperature data determined from the analysis image region position to a functional state of the respective support rollers.

According to another embodiment of the invention, it can be advantageous if the device is configured such that the data processing device (data processing system) has at least one trainable artificial neural network, by means of which at least one of the following detections is carried out: the detection of support rollers or subregions of support rollers for the automatic determination of image data regions in the captured image data, in which at least one subregion of a support roller is imaged, the detection of thermal image data of a support roller for the automatic determination of temperature data of the support roller in a defined analysis image region position of the support roller, the detection of functional states of a support roller from the determined temperature data of the support roller for the automatic assignment of the functional state of the support rollers.

Essential components and individual optional components of such a device for the machine-based determination of the functional state of the support rollers of a belt conveyor system have already been described above. The data processing device has an image region identification module, an image region definition module, and a state identification module. In addition, the image region identification module can have an image region detection module and an interface module, and the state identification module can have an analysis module and an assignment module. Depending on the specific design, the data processing device for evaluating the captured image data can be located on the vehicle itself or separated from it, for example as a server or computer cloud. If the data processing device is located on the vehicle, the data can be transmitted from the sensor system to the data processing device in a wireless data transmission or in a cable-based data transmission for further processing. If the data processing device is physically separate from the vehicle, the data transmission to the data processing device can be carried out wirelessly, e.g. as a radio transmission, or also by wired means if the vehicle is in its base station. Thus, any artificial neural network present can be implemented in the unmanned vehicle itself or separately from it, for example on an external data processing device.

In order to clarify the invention, representative examples are described in general in the following with reference to the corresponding figures, wherein individual sub-steps and sequences of the same are also explained, which can be linked together in almost arbitrary ways depending on the particular desired objectives of such a method. From these examples, further advantages and possible applications emerge, which will be described in more detail in the following without limiting the general inventive idea underlying these exemplary embodiments, and individual features and steps are also explained which can be linked together in almost arbitrary ways depending on the particular desired objectives of such a method. In the drawings, schematically in each case:

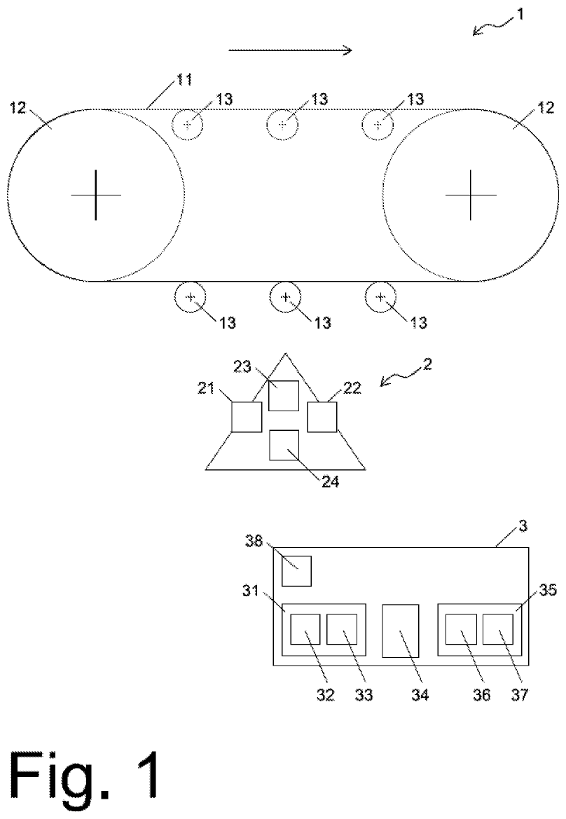

FIG. 1 shows a schematic representation of a belt conveyor system with a device for the machine-based determination of the functional state of the support rollers in accordance with one embodiment of the present invention,

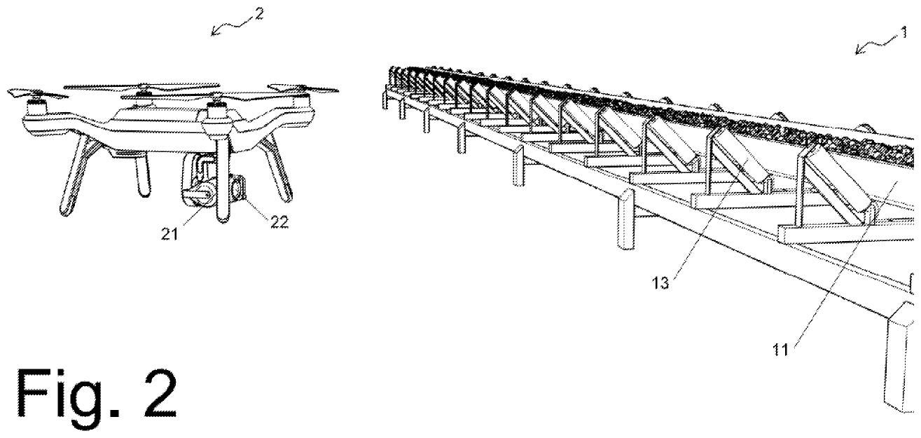

FIG. 2 shows a schematic perspective partial view of a belt conveyor system with a device for the machine-based determination of the functional state of the support rollers in accordance with a further embodiment of the present invention and

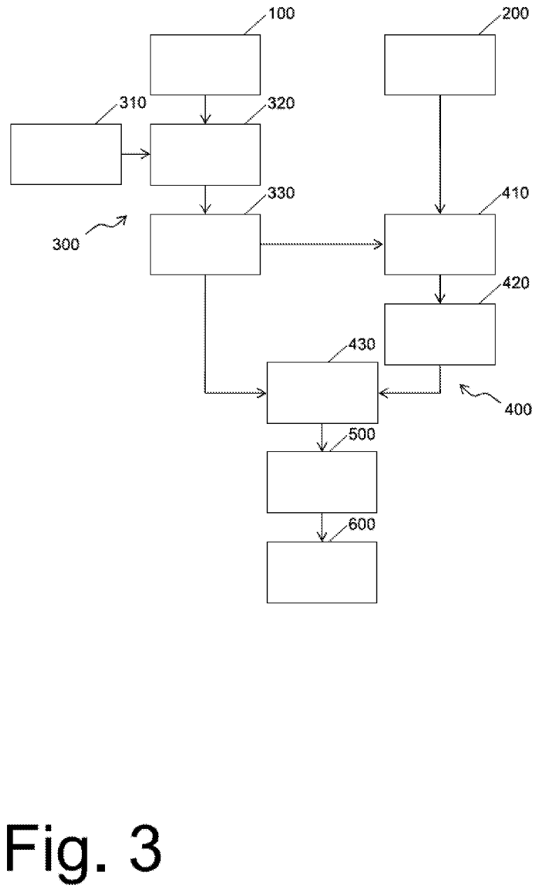

FIG. 3 shows a schematic representation of a method for the machine-based determination of the functional state of support rollers of a belt conveyor system in accordance with another embodiment of the present invention.

FIG. 1 shows a schematic representation of a belt conveyor system 1 with a device for the machine-based determination of the functional state of the support rollers 13 of the belt conveyor system 1 during operation of belt conveyor system 1 according to an embodiment of the present invention. The belt conveyor system 1 shown in FIG. 1 comprises a conveyor belt 11, which is deflected by two deflection rollers 12, of which one deflection roller 12 is designed as a drive drum (in this case the deflection roller 12 shown on the right). The upper run of the conveyor belt 11 forms the load run, over which the conveyed material is moved in the conveying direction (indicated by an arrow). The conveyor belt 11 is supported by support rollers 13 in both the upper and lower runs. In the present case, the conveyor belt 11 is guided flat so that the support rollers 13 are aligned horizontally in the support roller stations; a guidance is also possible here as a troughed conveyor belt or a rolled conveyor belt, wherein the support rollers are then arranged in the support roller stations in a U-shape or V-shape or O-shape.

An unmanned vehicle 2 is arranged on the belt conveyor system 1. This is an autonomously traveling vehicle or a remote controlled vehicle controlled by an operator, for example by means of a remote radio control. The vehicle 2 is an earthbound land vehicle, but it can also be designed differently, for example as an aircraft. The unmanned vehicle 2 moves along the entire belt conveyor system 1. In addition, multiple unmanned vehicles can also be assigned to the belt conveyor system 1. For example, it can be provided that each vehicle from a plurality of unmanned vehicles may only move in one subsection of the belt conveyor system 1, so that every vehicle 2 of this plurality is required to sense the entire belt conveyor system 1.

The unmanned vehicle 2 has an imaging sensor system that include a thermal imaging sensor device 21 and a photographic image sensor device 22. Thermal imaging sensor device 21 and photographic image sensor device 22 are located close together and have the same orientation and essentially the same imaging angle, so that they capture essentially the same object space. The thermal imaging sensor device 21 is a thermal imaging camera and the photographic image sensor device 22 is a photographic camera (monoscopic or stereoscopic), wherein both cameras record the captured image data electronically in digital form. The cameras can record single images or else corresponding moving images (film recordings) as image data. In addition, the unmanned vehicle 2 has a position determination device 23 to record the current position of the vehicle 2 in correlation with the image data captured in each case as position data; in this case, it is a GPS module, wherein the position information is inserted into the image data as meta-information. Alternatively, the photographic image sensor device 22 can be used for position determination, and even the thermal imaging sensor device 21 if necessary. In addition, the sensor system of the vehicle 2 has orientation detection in order to determine the respective orientation as orientation information when capturing the image data, in this case an inertial measuring unit.

The recorded image data, the position data and the orientation information are transmitted via a data transmission module 24 to a data processing device 3 where they are evaluated. In this case, the data processing device 3 is implemented separately from the vehicle 2, for example in the vicinity of the control station of the belt conveyor system 1. Instead, the data processing device 3 can also be arranged on the vehicle 2.

In the data processing device 3, the data transmitted by the data transmission module 24 of the unmanned vehicle 2, including the image data—the thermal image data from the thermal imaging camera and the photographic image data from the optical camera—is received by the data transmission module 38 of the data processing device 3. The photographic image data (and also, if applicable, the thermal image data) is first fed to an image region identification module 31, where it serves as input data from an image region detection module 32 of the image region identification module 31. In the image region detection module 32, image regions in which support rollers 13 or subregions of support rollers 13 are imaged are automatically detected. The positions of the detected image regions (identification image region positions) are provided for further processing via an interface module 33 of the image region identification module 31. From the interface module 33, the image region definition module 34 obtains the positions of the image regions detected in the photographic image data and automatically defines appropriate spatially corresponding image region positions in the thermal image data as analysis image region positions. The thermal image data with the analysis image region positions thus defined is forwarded to the functional state identification module 35. Within the state identification module 35, the thermal image data is automatically analyzed in an analysis module 36, wherein the analysis is limited here to the appropriately defined image region positions of the support rollers 13. The results of this analysis are entered as temperature data into the assignment module 37, which based on the temperature data of a support roller 13 obtained from the thermal image data in the respective analysis image region positions, automatically assigns a functional state to this support roller 13.

The data processing device 3 has a plurality of trainable artificial neural networks (not shown). One of these trainable artificial neural networks is used to detect support rollers 13 and subregions of support rollers 13 in order to identify image data regions in the captured image data, in which at least one subregion of a support roller 13 is imaged. Another of these trainable artificial neural networks is used to detect thermal image data of a support roller 13 in order to automatically determine the temperature data of the support roller 13 in a defined analysis image region position of the support roller 13. Another of these trainable artificial neural networks is used to detect functional states of a support roller 13 from the determined temperature data of the support roller 13, in order to automatically assign a functional state to the respective support rollers 13. Artificial neural networks are also used for the corresponding machine learning processes.

A schematic perspective partial view of a belt conveyor system 1 with a special device for the machine-based determination of the functional state of the support rollers 13 of the belt conveyor system 1 during operation of belt conveyor system 1 according to a particular embodiment of the present invention is shown in FIG. 2. Only the upper run of the conveyor belt 11 and an unmanned vehicle 2 of the device for the machine-based determination of the functional state of the support rollers 13 of the belt conveyor system 1 are shown here. The conveyor belt 11 is guided as a troughed U-shaped conveyor belt, the guidance is achieved by three support rollers 13 per support roller station, which are arranged in the form of a trapezoid resting on the shorter base side, with the longer base side being open. In each support roller station, one support roller 13 is arranged horizontally on the shorter base side, while the remaining two support rollers form the legs of the trapezoidal unit. Image data of the belt conveyor system 1 is captured by the unmanned vehicle 2, which in the present case is designed as an autonomous drone in the form of a quadrocopter. The vehicle 2 moves in a hovering (flying) motion parallel to the conveying direction (in the conveying direction or opposite to the conveying direction) near to the upper run of the belt conveyor system 1. In addition to the unmanned vehicle 2, further unmanned vehicles may be provided, which may, for example, sense different subsections of the belt conveyor system 1. In its lower region, the vehicle 2 has an imaging sensor system consisting of a thermal imaging sensor device 21 and a photographic image sensor device 22. In addition, the sensor system has inertial sensors and an electronic compass (not shown), which are used to detect the orientation of the image sensor devices as orientation information (after prior calibration). Using the thermal imaging sensor device 21 and the photographic image sensor device 22 aligned parallel to the thermal imaging sensor device 21, image data from the support rollers 13 of the belt conveyor system 1 is captured. The photographic image sensor device 22 is also used for position determination by comparing the captured photographic image data with a previously created three-dimensional point cloud of the terrain and the belt conveyor system 1 so that a unique position is determined; together with the orientation information, a unique assignment of the support rollers 13 captured in the image data can thus be performed. Instead, the vehicle 2 can also have a separate position determination device 23, for example in the form of a GPS module. In the present embodiment, the captured image data and the position data from the vehicle 2 are transmitted as radio signals to a data processing device 3 (not shown), where an automatic data evaluation is carried out involving trainable artificial neural networks. Instead, the data can also be first stored in a storage device in the vehicle 2 and transmitted to the data processing device 3 only after the vehicle 2 has returned to a base station, in which the secondary batteries of the vehicle 2 are also charged. If a sufficiently large unmanned vehicle 2 is used, it is also possible to arrange the data processing device 3 together with a storage device on the vehicle 2 itself, so that the data evaluation then takes place on the vehicle 2.

The following describes a computer-based method for identifying functionally impaired support rollers 13, based on the method for the machine-based determination of the functional state of support rollers 13 of a belt conveyor system 1 during operation of the belt conveyor system 1. This method can be used in particular in the case of belt conveyor systems 1 described in connection with FIGS. 1 and 2, each having a device for the machine-based determination of the functional state of the support rollers 13. Individual sub-steps of this method are shown schematically in FIG. 3.

The method provides for an unmanned vehicle 2 with at least one imaging sensor system, by means of which at least sections of the belt conveyor system 1 can be sensed in the form of image data, wherein image data from at least one subregion of the belt conveyor system 1 is captured as thermal image data (step 200). In the captured image data of the belt conveyor system 1, at least one identification image region position is determined automatically (step 300), in which at least one subregion of a support roller 13 is imaged. For each identification image region position determined from the image data, an analysis image region position is automatically defined in the thermal image data (step 410). In each defined analysis image region position, thermal image data is automatically analyzed (step 400) to automatically determine the functional state of support rollers 13.

The at least one unmanned vehicle 2 with the at least one imaging sensor system comprising at least one thermal imaging sensor device 21 is moved along at least one subregion of the belt conveyor system 1 to capture the thermal image data. Using the imaging sensor system of the unmanned vehicle 2, which moves along the main section (conveying direction) of the belt conveyor system 1, photographic image data is captured (step 100) and thermal image data is captured (step 200) in sections of the belt conveyor system 1. The unmanned vehicle 2 can be an autonomous unmanned vehicle or a remote controlled unmanned vehicle. In particular, drones or robots can also be considered as autonomous unmanned vehicles. Such a vehicle 2 can be designed in principle as a track-bound or track-less vehicle, in particular as a land vehicle or as an aircraft (for example as a quadricopter).

In step 100, the imaging sensor system is used to capture photographic image data from at least one subregion of the belt conveyor system 1 and in step 200, the imaging sensor system is used to capture thermal image data from this at least one subregion of the belt conveyor system 1. The image data captured by the imaging sensor system of this vehicle 2 represents support rollers 13 of a subregion of the belt conveyor system 1 either completely or partially, in particular including the bearings (anti-friction bearings) of the corresponding support rollers 13. The photographic image data and thermal image data in this case are static monoscopic recorded images, i.e. digital photographs or digital thermal images. However, other types of image data can be used instead, such as the corresponding moving images (moving images, videos), stereoscopic images and the like.

In addition to the spatially resolved image information, the photographic image data also contains the exact position (location position) at which the picture was taken (i.e. in the form of the position of the vehicle 2), as well as the orientation information indicating the orientation at which the photographic image sensor device 22 took the picture (alternatively or additionally, the corresponding information may also be included in the thermal image data). This additional information is stored in the corresponding image files in addition to the pixel data as metadata. Instead, this information can of course also be stored and transmitted separately from the image data, provided the information can be uniquely assigned to the corresponding image data, for example via a common time stamp. The position is determined by means of a position determination device 23 that is provided on the vehicle 2 itself or in a data processing device 3. In the present case, the position determination device 23 is a device for radio-based position determination, namely for satellite-based position determination by means of GPS. Instead, other devices and methods can also be used for determining position, for example a position determination based on optical environment detection, for example by comparing image data with previously captured image data or by comparing image data with a previously created three-dimensional terrain model, such as a three-dimensional point cloud, which also images the corresponding subregion of the belt conveyor system 1.

The image data is buffered during or after the recording and then transmitted—for example immediately afterwards, at fixed time intervals, or after the vehicle 2 has returned to a base station—to a data processing device 3. In the data processing device 3, the data is automatically processed and stored together with the results of such a data processing as target data, for example in the form of databases. The target data obtained in this way is made available to potential users via an interactive communication interface (interface), for example to the operator's employees, the service personnel, maintenance technicians and the like.

In step 300, image data regions are automatically detected in the captured image data of the belt conveyor system 1, in which regions at least one subregion of a support roller 13 is imaged. This step includes automatic detection of image data regions (step 320) and automatic provision of detected image data regions as identification image region positions (step 330), as well as improving the recognition quality of the automatic detection (step 310). At the end of step 300, the position of the detected image data region is automatically provided as the identification image region position of the respective support roller 13 (step 330).

In this case, the image data is photographic image data and the image data regions are photographic image data regions. In the photographic image data, photographic image data regions in which at least one identifiable object is imaged are thus automatically recognized (step 320). In the photographic image data regions detected in this way, support rollers 13 or their subregions are automatically detected among the identifiable objects. This enables the detection and identification of objects, in particular of support rollers 13 and the associated bearings (anti-friction bearings), on the basis of this photographic image data. For each detected support roller 13 and for each detected subregion of a support roller 13, the position of the photographic image data region in which the support roller 13 or the subregion of the support roller 13 is imaged is provided for further processing as an identification image region position (object position and object class) (step 330).

The automatic detection (step 320) of image data regions represents a central operation within step 300. In this case, the automatic detection 320 of image data regions is based on a machine learning algorithm. The recognition quality in the automatic determination of the identification image region position in the captured photographic image data, in particular the recognition quality of the automatic recognition of photographic image data regions in which at least one identifiable object is imaged (primarily at least one subregion of a support roller 13) and/or the recognition quality of the automatic recognition of support rollers 13 or subregions of support rollers 13 in the detected photographic image data regions, is improved by means of a learning procedure (step 310), which is carried out using an artificial neural network based on training data (training images), such as photographic image data in which such image regions have been manually marked with position and object designation, in which the objects to be learned are imaged—in particular, support rollers 13 or subregions of support rollers 13. By means of the training data, the recognition quality in the classification is improved, among other things. In addition, other objects characteristic of the belt conveyor system 1 may be marked in the training data, such as subregions of support frame elements, the conveyor belt 11 and the like. In this case, the training data also contains the verified object class assigned to the detected object as an identifier. The artificial neural network here is a multi-level convolutional neural network consisting of two “convolutional neural network” modules. The first module is designed to provide a preliminary classification of image data regions in the photographic image data where different objects might be located. The result of this preliminary classification is then transferred to the second module to perform an object-based classification in the potentially relevant image data regions identified in this way. The result of this classification of photographic image data returns the object class assigned to the detected object (the object name, for example, “support roller”, “bearing”, “steel cable” or the like), which is assigned a probability value from a range of 0 to 1. The object class with the highest probability value represents a result of this evaluation. The evaluation of the image also returns the associated position of the classified object within the image data. In this case, the position of such an object is defined by four numbers, namely by two pairs of x/y coordinates, each corresponding to point positions in the image. The two points in the photographic image data associated with the point positions span a rectangle as opposite edges of a rectangular selection frame in which the object is centrally positioned. Depending on the photographic image data examined, multiple objects can be identified simultaneously in one photographic image.

The image data of the belt conveyor system 1 is assigned to a position in the belt conveyor system 1. Additionally or instead, for defined analysis image region positions, the thermal image data or evaluation information is assigned to an individual support roller 13 of the belt conveyor system in each case. The assignment is performed in particular using a radio-based position determination, from a comparison of captured image data with reference image data, by detecting a route traveled by the unmanned vehicle 2, and/or by means of an orientation detection of the imaging sensor system. Such an assignment can be made at any point in the method before a comparison with historical data takes place. For this purpose, the belt conveyor system 1 is initially measured and the exact detection position (such as the GPS position) of each individual support roller 13 is determined. For a particularly reliable analysis, a three-dimensional digital model of the belt conveyor system 1 can also be created for this purpose (this can also be used as an intuitively comprehensible display of the identified information). Each image recording and thermal image recording will then include the position of the vehicle 2 (in the form of GPS coordinates) as metadata, as well as information on the orientation of the image sensor devices during data capture (such as via an internal electronic compass, an inertial measurement unit, or the pivot angle display of a robotic arm), thus enabling the precise assignment of the identified objects from the image recognition (step 320) to a specific support roller 13 of the belt conveyor system 1. In order to ensure an exact assignment, here a GPS module has been chosen which offers position detection based on a differential GPS procedure with a resolution of the GPS position in the centimeter range. Alternatively, the position can also be determined optically via an image comparison. The current (two-dimensional) photographic camera image (captured by means of a monoscopic camera) or a point cloud (3D point cloud, captured by means of a stereoscopic camera, a moving monoscopic camera, a scanning laser, lidar, radar or the like) is compared with two-dimensional photographic images with known positions or with a geo-referenced point cloud. In addition, it is also possible to determine the position in the near-range radio fields, for example via RFID transponders that are arranged in the support roller stations of the respective support rollers 13 and that are read out via a corresponding reader device in the vehicle 2. The position determination is carried out by radio-based methods at the time of the image data capture; image data can also be compared at a later time on the basis of captured image data. In this case, the position determination is carried out using GPS simultaneously with step 100 and/or 200, so that the location information is stored together with the image data and the orientation data and an assignment to specific support rollers 13 is then performed after the automatic recognition of image region data (step 320).

In step 410, for each identification image region position of a support roller 13 determined from the image data and provided, an analysis image region position of the support roller 13 is automatically defined in the thermal image data, which corresponds spatially to the respective identification image region position from the image data. In the subsequent automatic analysis of thermal image data (step 400), the corresponding temperature data of the support rollers 13 is determined only for the thermal image data in the analysis image region positions and subjected to an analysis (thermal analysis) in order then to assign the respective functional state (wear state) to the support rollers 13 and their bearings. Since the thermal imaging sensor device 21 and the photographic image sensor device 22 are a short distance apart, are rigidly aligned in the same direction with respect to the vehicle 2, and both sensor devices capture the image data approximately simultaneously, the information from the object detection described above in the photographic image data (step 300) can be transferred to the thermal image data (due to the known offset between the two image sensor devices, an offset can be calculated). If an object in the photographic image data has been identified and marked as a support roller 13, then in step 410 the rectangular selection frame, which in the photographic image data includes the support roller 13, is defined in the thermal image data as an analysis image region position and therefore also marked in the thermal image. The subsequent thermal analysis is then limited to thermal image data within this selected analysis image region.

In step 400, the selected thermal data is automatically analyzed in the defined analysis image region position of the support roller 13. To do this, temperature data of the respective support roller 13 is first automatically determined from the thermal image data in the defined analysis image region positions (step 420). The temperature data determined in the analysis image region is then automatically assigned to a functional state of the respective support rollers 13 (step 430). Step 400 therefore includes the automatic determination of temperature data (step 420) and the automatic assignment of the temperature data to a functional state (step 430), but not the automatic definition of the analysis image region position (step 410—however, a method sequence would also be possible in which the automatic definition of the analysis image region position is part of an automatic analysis of the thermal image data).

In step 420, thermal image data is automatically analyzed at each defined analysis image region position. To this end, in this step thermal image data that is thermal image data of the support rollers 13 is first automatically selected within the defined analysis image region positions. The thermal data thus selected in the defined analysis image region positions is then automatically analyzed.

To ensure that the thermal analysis is carried out on the support roller 13 and its bearings and not on other objects such as the conveyor belt 11 or on steel cables, which may also be located in the rectangular selection frame defined as the analysis image region, subregions are defined within the analysis image region position with two different selection methods. This makes it possible to keep the object region as small as possible for the subsequent actual data analysis. To do this, subregions of the thermal image data that contain thermal image data arranged in circular or near-circular contours are automatically selected within the defined analysis image region positions. In addition, subregions of the thermal image data in which the thermal image data corresponds to temperatures of an equal temperature level are automatically selected within the defined analysis image region positions. In the first selection procedure, the selection frame is therefore examined for circular contours. The region for inspecting the bearing of the support roller 13 is then defined as the average of all circular contours, which are consequently selected. In the second selection procedure, multiple regions with the same temperature level are selected based on the temperature distribution in the selection frame (the term temperature level includes a certain temperature range, the width of which must be selected according to the specific operating conditions of the belt conveyor system 1). In order to combine the two selection procedures, the positions of the subregions selected in the first selection procedure are compared with the positions of the subregions selected in the second selection procedure within each analysis image region position. The subregion, the thermal image data of which is subjected to the following actual thermal analysis is given by the joint intersection set (intersection surface) of the subregions selected in the two selection procedures. The combination of the two selection procedures provides a particularly high level of confidence that the automatically selected thermal image data is actually representative of the support rollers 13 and their bearings. In addition, the recognition quality in the automatic selection of the thermal image data, which is thermal image data of the support rollers 13, in particular in the automatic selection of the thermal image data which lies in such subregions within the defined analysis image region positions where thermal image data is arranged in circular or near-circular contours and/or where thermal image data corresponds to the temperatures of an equal temperature level, is improved by using a learning procedure carried out using an artificial neural network, namely a multi-level convolutional neural network which has two convolutional neural network modules.

In step 430, the temperature data determined from the analysis image region position is automatically assigned to a functional state of a support roller 13, by either automatically classifying the determined temperature data of the respective support roller 13 to one functional state of a plurality of previously defined functional states or by automatically assigning said data to a functional state as part of a cluster analysis, in particular as part of a multivariate cluster analysis. In addition, the recognition quality in the automatic determination of the functional state of support rollers 13, in particular the classification of the thermal image data, is improved by means of a learning procedure carried out by means of an artificial neural network. In the selected regions, characteristic features of the temperature, such as the maximum temperature, the minimum temperature, the temperature mean, the temperature median and characteristic features of the temperature distribution are extracted (e.g. their width, symmetry, or any hotspots). The automatic assignment to a functional state 430 is performed here by means of a multivariate clustering algorithm, by which the totality of the characteristic features of each support roller 13 and its bearings are assigned to one of a number of wear states. In the present case, this is an assignment to “Replacement required”, “Replacement required soon”, “Replacement not yet foreseeable”. This clustering algorithm is continuously trained, for which suitably verified information about the actual functional state of support rollers 13 is entered as training data, such as that obtained after a manual check as part of an inspection or maintenance for verification of the functional state.

The acquisition of the image data and its analysis, i.e. the method for the machine-based determination of the functional state of support rollers 13 of a belt conveyor system 1 during operation of the belt conveyor system 1 (steps 100-400), is carried out at regular time intervals. For each support roller 13, functional state, image data and determined temperature data are recorded in a functional state data collection, in particular in a functional state database (not shown). In this functional state data collection, each support roller 13 of the belt conveyor system 1 is captured with its exact GPS position and its respective specification; this includes, for example for the support roller 13, its size, material, manufacturer, type number, installation date and the like. For each support roller 13, in each acquisition cycle the storage paths of the associated image data (as raw data and as processed data after processing) and the analysis results are also stored with a time stamp. In addition to the position (support roller 13 and its bearings) and the temperature data, in particular the characteristic temperature parameters such as maximum temperature, minimum temperature, mean temperature, median temperature and the temperature distribution, the stored analysis results also include the determined functional states (as wear state classes). In addition, additional information such as temperature limits (for example, 80° C. for an imminent replacement and 90° C. for an immediate replacement), pending maintenance operations and the like can be stored for each support roller 13.

Via an interactive communication interface (local user interface or online user interface, for example via locally installed computer programs or via mobile or web-based application programs or applications), the data stored in the functional state data collection can be accessed and retrieved, for example in order to display the corresponding information visually. In this way, service personnel or maintenance technicians can display markings and listings of all support rollers 13 requiring maintenance along with their GPS positions, or add relevant photographs and comments interactively during inspection and maintenance of support rollers 13 for documentation purposes, for example, a manual assessment of the wear state or a list of the specific maintenance work and replacement activities carried out. This information is then stored in a database with a time stamp and can be used to improve the quality of the classification as part of a machine learning procedure. Furthermore, the functional state data collection can also be used to display the exact positions of the support rollers 13 on a map display based on available map material, satellite images, or a three-dimensional digital model of the belt conveyor system 1. For example, a user can interactively select individual support rollers 13 on the map in order to view additional information on these support rollers 13. In addition, current functional states/wear states as well as selected temperature characteristics of all support rollers 13 can be displayed in an overview diagram. The data on the support rollers 13 can also be retrieved in list form, wherein individual support rollers 13 can also be selected interactively in this display and their information viewed and comments on individual support rollers 13 can be stored, wherein the temperature profile of the respective support roller 13 can be displayed or its thermal image data and the photographic image data can be displayed, also as a chronology of the historical values including all changes.

In addition to the method described above for the machine-based determination of the functional state of support rollers 13, the method shown in FIG. 3 for identifying functionally impaired support rollers 13 of a belt conveyor system 1 during operation of the belt conveyor system 1 also comprises the detection of functionally impaired support rollers 13 by comparing the functional state and the temperature data with historical data from a functional state database (step 500). On the basis of this comparison, a time for the replacement of the respective support roller 13 is determined (step 600). In connection with such predictive maintenance, the described method can therefore be used to monitor the functional states of all support rollers 13 at short intervals without additional personnel and to identify critical support rollers 13 at an early stage when performing repeated inspection measures. In addition, the temporal evolution of the thermal characteristics can be analyzed by extrapolation or regression analysis (step 500), so that a forecast of the expected remaining service life of the support roller 13 can be prepared and an optimal time for maintenance can be recommended (step 600). The times determined for the respective support rollers 13 are output to a communication interface, for example in the form of a screen display, as an automatically created calendar entry in an appointment management program, as an automatic order for support rollers or consumables from the manufacturer or dealer or—in the case of an immediate, urgently required replacement—also as a warning signal, possibly combined with a process-control intervention to stop the belt conveyor system 1, in order to avoid any consequential damage such as that which can occur on the conveyor belt 11, for example.

The method described above for the machine-based determination of the functional state of support rollers 13 of a belt conveyor system 1 during operation of the belt conveyor system 1 and in particular also the method described above for the identification of functionally impaired support rollers 13 of a belt conveyor system 1 during operation of the belt conveyor system 1 are each implemented in the form of a computer program which is configured to perform each step of these methods. This computer program is stored on a machine-readable data carrier.

### LIST OF REFERENCE SIGNS

1 belt conveyor system
11 conveyor belt
12 deflection roller
13 support roller
2 unmanned vehicle
21 thermal image sensor device
22 photographic image sensor device
23 position determination device
24 data transfer module
3 data processing device
31 image region identification module
32 image region detection module
33 interface module
34 image region definition module
35 state identification module
36 analysis module
37 assignment module
38 data transfer module
100 capturing photographic image data
200 capturing thermal image data
300 automatic determination of at least one identification image region position
310 improving the recognition quality of the automatic identification
320 automatic detection of image data regions
330 automatic provision of identified image data regions as identification image region position
400 automatic analysis of thermal image data
410 automatic determination of analysis image region position
420 automatic determination of temperature data
430 automatic assignment to a functional state
500 comparison with historical data from functional state database
600 determination of the time for replacement

1. A method for the machine-based determination of the functional state of the support rollers (13) of a belt conveyor system (1) during operation of the belt conveyor system (1), wherein at least one unmanned vehicle (2) with at least one imaging sensor system is provided, by means of which at least sections of the belt conveyor system (1) can be sensed in the form of image data, wherein image data of at least one subregion of the belt conveyor system (1) is captured as thermal image data,
characterized in that
in the captured image data of the belt conveyor system (1) at least one identification image region position, in which at least one subregion of a support roller (13) is imaged, is automatically determined,
for each determined identification region position from the image data an analysis image region position is automatically defined in the thermal image data, and in each defined analysis image region position, thermal image data is automatically analyzed in order to determine the functional state of support rollers (13).

2. The method as claimed in claim 1, wherein
image data of at least one subregion of the belt conveyor system (1) is captured as thermal image data by moving the at least one unmanned vehicle (2) with the at least one imaging sensor system, comprising at least one thermal image sensor device (21) for capturing the thermal image data, along at least one subregion of the belt conveyor system (1), image data from at least one subregion of the belt conveyor system (1) is captured with the imaging sensor system and the image data comprises at least thermal image data,
in the captured image data of the belt conveyor system (1) the at least one identification image region position is automatically determined by automatically detecting image data regions in the captured image data, in which regions at least one subregion of a support roller (13) is imaged, and the position of the respectively detected image data region is automatically provided as the identification image region position of the respective support roller (13), for each identification image region position determined from the image data an analysis image region position is automatically defined in the thermal image data by automatically defining, for each identification image region position of the support roller (13) identified from the image data, an analysis image region position of the support roller (13) in the image data, which position corresponds spatially to the respective identification image region position from the image data, by automatically analyzing the thermal image data in each defined analysis image region position, by automatically determining temperature data of the relevant support roller (13) from the thermal image data in the defined analysis image region position of the support roller (13), and automatically assigning the temperature data determined from the analysis image region position to a functional state of the respective support rollers (13).

3. The method as claimed in claim 1 or 2, wherein the image data that can be detected by the imaging sensor system also comprises photographic image data in addition to the thermal image data, wherein image data of at least one subregion of the belt conveyor system (1) is also captured as photographic image data, the captured image data of the belt conveyor system (1), in which at least one identification image region position is determined automatically, is photographic image data in which photographic image data regions are automatically detected as image data regions, and the position of each detected photographic image data region is automatically provided as the identification image region position.

4. The method as claimed in any one of claims 1 to 3, wherein the at least one identification image region position is automatically determined in the captured image data of the belt conveyor system (1) by automatically detecting image data regions in the image data in which at least one detectable object is imaged, automatically detecting support rollers (13) or subregions of support rollers (13) among the detectable objects in the image data regions thus detected, and for each detected support roller (13) and for each detected subregion of a support roller (13), providing the position of the image data region in which the support roller (13) or the subregion of the support roller (13) is imaged as an identification image region position.

5. The method as claimed in any one of claims 1 to 4, wherein the recognition quality in the automatic determination of the identification image region position in the captured image data, in particular the recognition quality of the automatic detection of image data regions in which at least one detectable object is imaged, in particular at least one subregion of a support roller (13), and/or the recognition quality of the automatic detection of support rollers (13) or subregions of support rollers (13) in the detected image data regions is improved by means of a learning procedure carried out by means of an artificial neural network, in particular by means of a single-level or multi-level convolutional neural network.

6. The method as claimed in any one of claims 1 to 5, wherein in each defined analysis image region position, thermal image data is automatically analyzed by automatically selecting thermal image data in the defined analysis image region positions, which is thermal data of the support rollers (13), and the selected thermal data in the defined analysis image region positions is automatically analyzed.

7. The method as claimed in claim 6, wherein thermal image data is automatically selected that lies in those subregions within the defined analysis image region positions in which thermal image data is arranged in circular or near-circular contours and/or in which thermal image data corresponds to the temperatures of an equal temperature level.

8. The method as claimed in claim 6 or 7, wherein the recognition quality in the automatic selection of the thermal image data, which is thermal image data of the support rollers (13), is improved by means of a learning procedure carried out by means of an artificial neural network, in particular the recognition quality in the automatic selection of the thermal image data, which lies in such subregions within the defined analysis image region positions in which thermal image data is arranged in circular or near-circular contours and/or in which thermal image data corresponds to the temperatures of an equal temperature level.

9. The method as claimed in any one of claims 1 to 8, wherein the image data of the belt conveyor system (1) is assigned to a position in the belt conveyor system (1) and/or for defined analysis image region positions the thermal image data or evaluation information is assigned to an individual support roller (13) of the belt conveyor system (1), the assignment being performed in particular via a radio-based position determination, by comparing captured image data against reference image data, by recording the route traveled by the unmanned vehicle (2), and/or by detecting the orientation of the imaging sensor system.

10. The method as claimed in claim 2 or any one of claims 3 to 9 referring back to claim 2, wherein the temperature data determined from the analysis image region position is automatically assigned to a functional state of a support roller (13), by either automatically classifying the determined temperature data of the respective support roller (13) to one functional state of a plurality of previously defined functional states or by automatically assigning said data to a functional state as part of a cluster analysis, in particular as part of a multivariate cluster analysis.

11. The method as claimed in any one of claims 1 to 10, wherein the recognition quality in the automatic determination of the functional state of support rollers (13), in particular the classification of the thermal image data, is improved by means of a learning procedure carried out by means of an artificial neural network.

12. The method as claimed in any one of claims 1 to 11, wherein the functional state, the image data and/or, if applicable, the determined temperature data for the respective support roller (13), are recorded in a functional state data collection.

13. A method for identifying functionally impaired support rollers (13) of a belt conveyor system (1) during operation of the belt conveyor system (1), the method comprising the method for the machine-based determination of the functional state of the support rollers (13) of a belt conveyor system (1) as claimed in any one of claims 1 to 12, wherein functionally impaired support rollers (13) are detected, a time for replacement of the respective support roller (13) is determined based on a comparison with historical data from a functional state database, and for this support roller (13) the determined time is output to a communication interface.

14. A computer program which is configured to execute each step of a method as claimed in any one of claims 1 to 13.

15. A machine-readable data storage carrier on which a computer program according to claim 14 is stored.

16. A device for the machine-based determination of the functional state of support rollers (13) of a belt conveyor system (1) during operation of the belt conveyor system (1), the device comprising
at least one unmanned vehicle (2) with at least one imaging sensor system that can be moved along at least one subregion of the belt conveyor system (1), by means of which sensor system at least some sections of the belt conveyor system (1) can be captured by sensors in the form of image data, and which comprises at least one thermal image sensor device (21) for capturing thermal image data,
a data processing device (3) for evaluating the captured image data in order to determine the functional state of support rollers (13) of a belt conveyor system (1) during operation of the belt conveyor system (1), the data processing device (3) having an image region identification module (31) which is configured to automatically identify in captured image data at least one identification image region position in which at least one subregion of a support roller (13) is imaged, an image region definition module (34) which is configured to automatically define an analysis image region position in the thermal image data for an identification image region position identified from the image data, and a state identification module (35) which is configured to automatically analyze thermal image data at a defined analysis image region position to automatically determine the functional state of support rollers (13).

17. The device as claimed in claim 16, wherein
the image region identification module (31) has an image region detection module (32) and an interface module (33), the image region detection module (32) of which is configured to automatically detect image data regions in the captured image data in which at least one subregion of a support roller (13) is imaged, and the interface module (33) of which is configured to automatically provide the position of the detected image data region as the identification image region position of the respective support roller (13),
and wherein the image region definition module (34) is configured to automatically define, for each identification image region position of a support roller (13) determined from the image data, an analysis image region position of the support roller (13) in the thermal image data that corresponds spatially to the respective identification image region position from the image data,
and wherein the state identification module (35) has an analysis module (36) and an assignment module (37), the analysis module (36) of which is configured to automatically determine temperature data of the respective support roller (13) in the defined analysis image region position of the support roller (13) from the thermal image data, and the assignment module (37) of which is configured to automatically assign the temperature data determined from the analysis image region position to a functional state of the respective support rollers (13).

18. The device as claimed in claim 17, wherein the data processing device (3) has at least one trainable artificial neural network, by means of which at least one of the following detections is carried out: the detection of support rollers (13) or subregions of support rollers (13) for the automatic determination of image data regions in the captured image data, in which at least one subregion of a support roller (13) is imaged, the detection of thermal image data of a support roller (13) for the automatic determination of temperature data of the support roller (13) in a defined analysis image region position of the support roller (13), the detection of functional states of a support roller (13) from the determined temperature data of the support roller (13) for the automatic assignment of the functional state of the support rollers (13).
